(19) United States
(12) Patent Application Publication
(10) Pub. No.: US 2008/0028180 A1
(43) Pub. Date: Jan. 31, 2008

(54) INAPPROPRIATE ACCESS DETECTOR BASED ON SYSTEM SEGMENTATION FAULTS

(76) Inventors: Alex P. Newman, Portland, OR (US); Tobias Kohlenberg, Portland, OR (US); John Mark Agosta, Palo Alto, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/461,417

(22) Filed: Jul. 31, 2006

(51) Int. Cl. G06F 12/00

(52) U.S. Cl. 711/206

(57) ABSTRACT

Embodiments of the present invention provide an inappropriate access detector of system segmentation faults. Other embodiments may be described and claimed.

### TECHNICAL FIELD

Embodiments of the present invention relate to the field of computing security and more particularly, to an inappropriate access detector based on system segmentation faults.

### BACKGROUND

Malicious software (malware), also referred to as a malicious memory exploit, often works by tricking a processor within a system into jumping to a location of memory where the exploit has loaded its own code. Generally, this has been possible by overwriting the stack return address to point to the “attack” code. While some strides have been made to protect against such events, most current malware may evade such protection by making a legitimate jump to a known system function that, in turn, may execute the exploit. A known defense against this is to randomize system library address entry points. This is generally referred to as Address Space Layout Randomization (ASLR). As a response to this defense, the malware generally must try multiple entry points in order to find one that is correct. Typically, the malware has no guarantee that such a trick will work the first time. On a system where “write or execute” memory pages and ASLR security technologies are enabled, a buffer overflow may still succeed in executing arbitrary codes through “brute force” guessing of the location in memory of the standard system libraries. However, each failed attempt should trigger a segmentation fault.

Contemporary operating systems may check if a running process attempts to read or write to memory addresses that do not belong to that particular process, or to which it does not have privileges to access. Upon discovery of such attempts, an error is caused that generates a segmentation fault. A segmentation fault is also often referred to as, for example, a Segfault, SIGSEG, Address error, General Protection Fault, access error, or a bus error. All such errors are referred to herein as segmentation faults, which should not be construed as limiting with regard to the present invention in any way.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates a computer system that may use an inappropriate access detector based upon system segmentation faults, in accordance with various embodiments of the present invention; and

FIG. 2 schematically illustrates components of the computer system of FIG. 1 with an inappropriate access detector based upon system segmentation faults, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide an inappropriate access detector (also referred to as a malicious activity detector) based on system segmentation faults.

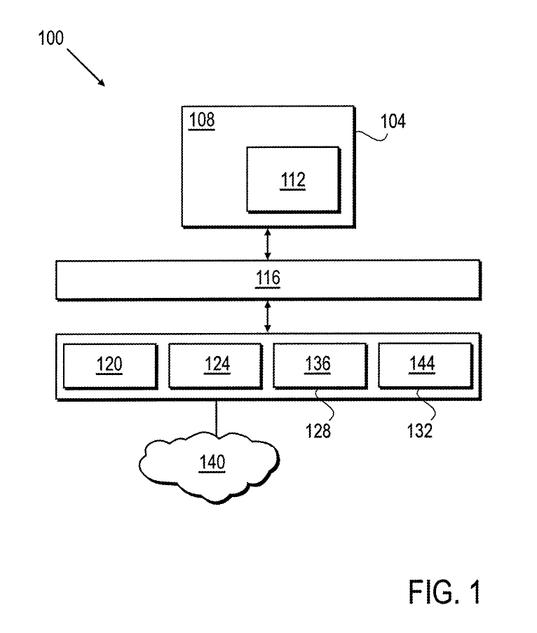

FIG. 1 schematically illustrates a computer system 100 that may include a malicious activity detector, in accordance with various embodiments of the present invention. The system 100 may have an execution environment 104, which may be the domain of an executing operating system (OS) 108. The OS 108 may be a component configured to execute and control general operation of other components within the execution environment 104, such as a software component 112, subject to management by a management module 116. The management module 116 may arbitrate general component access to hardware resources such as one or more processor(s) 120, network interface controller 124, storage 128, and/or memory 132.

In some embodiments, the component 112 may be a supervisory-level component, e.g., a kernel component. In various embodiments, a kernel component may be services (e.g., loader, scheduler, memory manager, etc.), extensions/drivers (e.g., for a network card, a universal serial bus (USB) interface, a disk drive, etc.), or a service-driver hybrid (e.g., intrusion detectors to watch execution of code).

The processor(s) 120 may execute programming instructions of components of the system 100. The processor(s) 120 may be single and/or multiple-core processor(s), controller(s), application specific integrated circuit(s) (ASIC(s)), etc.

In an embodiment, storage 128 may represent non-volatile storage to store persistent content to be used for the execution of the components of the system 100, such as, but not limited to, operating system(s), program files, configuration files, etc. In an embodiment, storage 128 may include stored content 136, which may represent the persistent store of source content for the component 112. The persistent store of source content may include, e.g., executable code store that may have executable files and/or code segments, links to other routines (e.g., a call to a dynamic linked library (DLL)), a data segment, etc.

In various embodiments, storage 128 may include integrated and/or peripheral storage devices, such as, but not limited to, disks and associated drives (e.g., magnetic, optical), universal serial bus (USB) storage devices and associated ports, flash memory, ROM, non-volatile semiconductor devices, etc.

In various embodiments, storage 128 may be a storage resource physically part of the system 100 or it may be accessible by, but not necessarily, a part of the system 100. For example, the storage 128 may be accessed by the system 100 over a network 140 via the network interface controller 124. Additionally, multiple systems 100 may be operatively coupled to one another via network 140.

Upon a load request, e.g., from a loading agent of the OS 108, the management module 116 and/or the OS 108 may load the stored content 136 from storage 128 into memory 132 as active content 144 for operation of the component 112 in the execution environment 104.

In various embodiments, the memory 132 may be volatile storage to provide active content for operation of components on the system 100. In various embodiments, the memory 132 may include RAM, dynamic RAM (DRAM), static RAM (SRAM), synchronous DRAM (SDRAM), dual-data rate RAM (DDRRAM), etc.

In some embodiments the memory 132 may organize content stored therein into a number of groups of memory locations. These organizational groups, which may be fixed and/or variable sized, may facilitate virtual memory management. The groups of memory locations may be pages, segments, or a combination thereof.

As used herein, the term “component” is intended to refer to programming logic and associated data that may be employed to obtain a desired outcome. The term component may be synonymous with “module” or “agent” and may refer to programming logic that may be embodied in hardware or firmware, or in a collection of software instructions, possibly having entry and exit points, written in a programming language, such as, for example, C++, Intel Architecture 32 bit (IA-32) executable code, etc.

A software component may be compiled and linked into an executable program, or installed in a dynamic link library, or may be written in an interpretive language such as BASIC. It will be appreciated that software components may be callable from other components or from themselves, and/or may be invoked in response to detected events or interrupts. Software instructions may be provided in a machine accessible medium, which when accessed, may result in a machine performing operations or executions described in conjunction with components of embodiments of the present invention. Machine accessible medium may be firmware, e.g., an electrically erasable programmable read-only memory (EEPROM), or other recordable/non-recordable medium, e.g., read-only memory (ROM), random access memory (RAM), magnetic disk storage, optical disk storage, etc. It will be further appreciated that hardware components may be comprised of connected logic units, such as gates and flip-flops, and/or may be comprised of programmable units, such as programmable gate arrays or processors. In some embodiments, the components described herein are implemented as software modules, but nonetheless may be represented in hardware or firmware. Furthermore, although only a given number of discrete software/hardware components may be illustrated and/or described, such components may nonetheless be represented by additional components or fewer components without departing from the spirit and scope of embodiments of the invention.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to program an apparatus to enable the apparatus to request from a proxy server one or more location restriction(s) to modify one or more user preference(s). In various ones of these embodiments, programming instructions may be adapted to modify one or more user preferences to subject the one or more user preferences to one or more location restrictions. In various embodiments, article of manufacture may be employed to implement one or more methods as disclosed herein in one or more client devices. In various embodiments, programming instructions may be adapted to implement a browser, and in various ones of these embodiments, a browser may be adapted to allow a user to display information related to a network access. In an exemplary embodiment, programming instructions may be adapted to implement a browser on a client device.

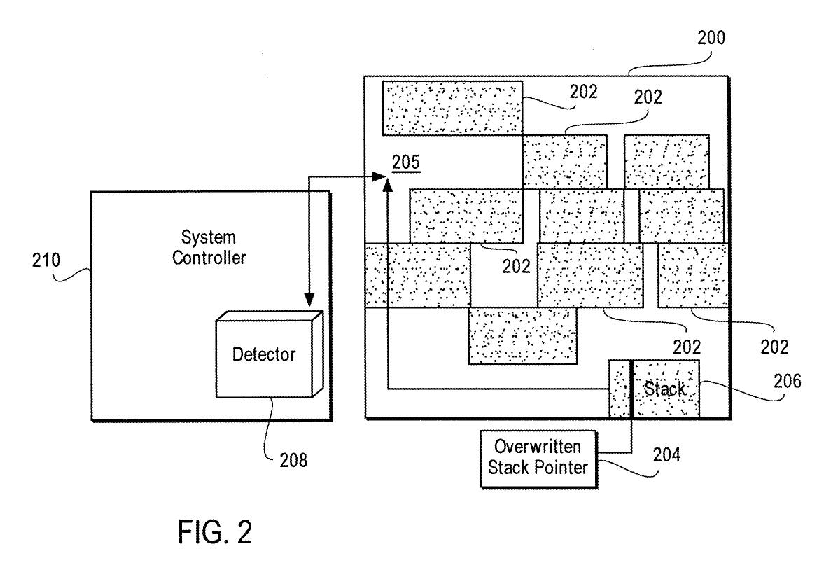

As may be seen in FIG. 2, a system library memory 200 layout is randomized such that the system library address entry points for applications 202 are organized randomly. Memory 200 generally corresponds to at least a portion of memory 132 of FIG. 1. In accordance with various embodiments of the present invention, a malware application overwrites the stack pointer 204 within the stack 206, thereby causing the stack pointer to attempt to read or write to a memory address entry point. Due to the randomization of the memory address entry points, the probability is extremely high that the jump will be to a non-existent entry point at 205. This will cause the system to generate a segmentation fault in response to the error.

In accordance with various embodiments of the present invention, a detector 208 monitors the system library (i.e., monitors calls to execute at locations in memory) for such segmentation faults. The detector detects the segmentation fault and alerts a control block that includes a system controller 210 of the possibility that the segmentation fault was generated by malware. The system controller may then determine that isolation and/or disconnection of at least a portion of the system 100 or an application is desirable. In accordance with various embodiments, the system controller may monitor the frequency and pattern of segmentation faults in order to determine whether or not to quarantine or disconnect at least a portion of the system. Such monitoring may be performed with regard to either a single system or host, or throughout an entire network of systems or hosts.

In accordance with various embodiments of the present invention, the detector may be implemented via a processor or chip set implementing technologies that include the capability to monitor a system or network such as, for example, Intel's Active Management Technology (AMT), LaGrande Technology (LT), and Vanderpool Technology (VT). Such technologies may be configured to monitor for segmentation faults and thus, in accordance with various embodiments of the present invention, the detector may be implemented by leveraging these technologies' capabilities for monitoring a system. Thus, in such an embodiment that includes such technologies, the detector may be integrated with the system controller. Additionally, in such an embodiment, the detector may perform the monitoring for segmentation faults from “outside” or “below” a system's operating system. This allows for a detector to operate in such a way that it may not be “fooled” by encryption of the malware and thereby disabled if the overall system becomes compromised. In accordance with various embodiments, the system controller may work in conjunction with the system's operating system, or the operating system may serve as the system controller.

In accordance with various embodiments of the present invention, the detector may be implemented with a component for kernel signal tracing, wherein a piece of kernel tracing software is attached to a root process. The kernel tracing may then follow any descending applications that are launched off that root process. This component may use string matching to detect a segmentation fault, and then send an alert to the system controller.

In accordance with various embodiments of the present invention, the detector may also be implemented via a kernel patch or driver. The kernel signal infrastructures may be overwritten so that any segmentation fault triggers the kernel to send the appropriate kernel alert to a system controller.

Accordingly, in accordance with various embodiments of the present invention, a detector monitors run-time software faults based upon the observation that a memory-based intrusion, e.g., a malicious memory exploit and/or a buffer overflow attack, is likely to generate faults on a machine, or within a system of machines, that has contemporary security precautions. Monitoring the frequency and pattern of such faults allows the present invention to detect the effects of malicious behavior in a highly sensitive fashion. Because such software fault detection relies on observations that are separate from traffic measurements, such an approach may be used in combination with network-based detectors (e.g. network traffic anomaly detectors), thus offering multiple lines of defense.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
monitoring, by a detector within a system, a system memory of the system having randomized address entry points for system applications of the system;
detecting, by the detector, a segmentation fault; and
alerting, by the detector, a system controller of the system that the segmentation fault may be a result of an inappropriate attempt to access a non-existent address entry point.

2. The method of claim 1, wherein monitoring a system memory of the system comprises using signal tracing attached at a root process to follow descending applications of the system that have launched.

3. The method of claim 2, wherein detecting a segmentation fault comprises using string matching.

4. The method of claim 1, wherein monitoring a system memory of the system comprises monitoring the system memory with one of a processor or chipset configured to operate as a detector.

5. The method of claim 4, wherein the one of a processor or chipset is further configured to serve as the system controller and the method further comprises isolating and/or disconnecting, by the system controller, at least a portion of the system, which includes the system memory, based upon detection of at least one segmentation fault.

6. The method of claim 4, wherein the one of a processor or chipset is further configured to serve as the system controller and the method further comprises monitoring, by the system controller, at least one of a frequency of segmentation faults or a pattern of segmentation faults.

7. The method of claim 6, wherein the method further comprises isolating and/or disconnecting, by the system controller, at least a portion of the system based upon the monitoring at least one of a frequency of segmentation faults or a pattern of segmentation faults.

8. An apparatus comprising:
a detector block configured to monitor a system memory of a system hosting the apparatus, the system memory being organized to include randomized address entry points for system applications of the system, the detector block being further configured to detect segmentation faults of the system and to alert a system controller of the system that a segmentation fault may be a result of an inappropriate attempt to access a non-existent address entry point.

9. The apparatus of claim 8, wherein the apparatus comprises a control block that serves as the system controller.

10. The apparatus of claim 9, wherein the control block is configured to monitor at least one of a frequency of segmentation faults or a pattern of segmentation faults.

11. The apparatus of claim 10, wherein the control block is further configured to isolate and/or disconnect at least a portion of the system based upon the monitoring at least one of a frequency of segmentation faults or a pattern of segmentation faults.

12. The apparatus of claim 10, further comprising a network traffic anomaly detector block and the control block is further configured to monitor output of the network traffic anomaly detector block.

13. An article of manufacture comprising:
a storage medium; and
a plurality of instructions stored in the storage medium and designed to implement a detector on a system to perform a plurality of detector operations, a system controller within the system to perform a plurality of system controller operations, or both;
the plurality of detector operations including:
monitoring a system memory of the system having randomized address entry points for system applications of the system;
detecting a segmentation fault; and
alerting a system controller of the system that the segmentation fault may be a result of an inappropriate attempt to access a non-existent address entry point;
the plurality of system controller operations including:
isolating at least a portion of the system based upon detection of at least one segmentation fault.

14. The article of manufacture of claim 13, wherein the system controller operations further include monitoring at least one of a frequency of segmentation faults or a pattern of segmentation faults.

15. The article of manufacture of claim 14, wherein the system controller operations further include isolating and/or disconnecting at least a portion of the system based upon the monitoring at least one of a frequency of segmentation faults or a pattern of segmentation faults.

16. A system comprising:
a memory having randomized memory address points for system applications;
a detector configured to monitor the memory, to detect segmentation faults, and to alert a system controller that the segmentation fault may be the result of an inappropriate attempt to access a non-existent address entry point;
a mass storage coupled to the memory; and
a bus coupling the detector to the memory.

17. The system of claim 16, wherein the detector is included within a device that includes a control block that serves as the system controller.

18. The system of claim 17, wherein the control block is configured to isolate and/or disconnect at least a portion of the system based upon detection of at least one segmentation fault.

19. The system of claim 18, wherein the control block is further configured to isolate and/or disconnect at least a portion of the system based upon the monitoring at least one of a frequency of segmentation faults or a pattern of segmentation faults.

20. The system of claim 18, wherein the device further comprises a network traffic anomaly detector block and the control block is further configured to monitor output of the network traffic anomaly detector block.
